(19) United States
(12) Patent Application Publication
(10) Pub. No.: US 2007/0300243 A1
(43) Pub. Date: Dec. 27, 2007

(54) Modular caching method and system for enabling offline functionality of server-client systems

(75) Inventors: Ran Gross, Rosh Ha'ayin (IL); Ariel Tammam, Ramat Gan (IL); Eliezer Levy, Haifa (IL); David Brutman, Ra'anana (IL); Shai Alfandary, Zur Moshe (IL); Guy Shalev, Herzlia (IL); Eran Kampf, Haifa (IL)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: SAP PORTALS ISRAEL LTD.

(21) Appl. No.: 11/472,935

(22) Filed: Jun. 22, 2006

(51) Int. Cl. G06F 9/46

(52) U.S. Cl. 719/330

(57) ABSTRACT

A method of managing a cache in a server-client system, defining potential cacheable service-calls and associating them with validity condition, storing all cacheable service-call responses in the cache and providing service-call responses to service-calls that have a valid matching service-call response stored in the cache, further loading the cache according to prediction directives.

### FIELD OF THE INVENTION

The present invention relates generally to the field of server-client caching solutions and more particularly to a method and system for enabling offline functionality and shortening response time of server-client systems.

### BACKGROUND OF THE INVENTION

The expression server-client system refers to a computing model in which there is a separation between a user that is operating with a client and a remote server that provides responses to service-calls sent by the client.

While there are a lot of sub categories of the server-client computing model, the typical server-client system is a system in which a user requests services, referred to as service-calls, from a remote server. The service-calls are typically simple questions concerning data that is stored in the server's database, for example a sales manager inquires regarding the number of cars of a certain type that were sold during the previous year, a tourist agent inquires regarding the number of available seats on a certain flight or an insurance agent inquires regarding the expiration date of a certain insurance policy.

The typical topology of such server-client systems is characterized by a relatively large data base located at the server together with a relatively complex business logic software and high computing capability. In contrast the client includes mainly resources that are required for graphical display and communication with the remote server. The typical process in these systems comprises sending a simple question (i.e. service-call) from the client to the server which may reside at another location. The server's business logic retrieves data from the database, manipulates the data and sends the required answer (i.e. service-call response) to the client. The client processes the data and updates the display accordingly.

It should be noted that the term server-client includes many sub categories, for example “2-tier systems” or “3-tier systems”, however, since the present invention is not restricted to a specific sub category it will be described generally as a server-client system.

There are a lot of advantages to this computing model. The main advantage is that this topology enables relatively easy maintenance. Most of the data and software are installed at a single central unit. Whenever updates or upgrading of the software or database are required—the entire procedure is conducted at a single site (or very few sites if the server side is a distributed one) and is transparent to all the users that are interacting only with the client side.

However, this common topology of server-client suffers some inherent drawbacks.

The main drawback of the server-client computing model is the almost absolute dependency of the system on the server and the communication network leading to the server. If either the communication network or the server is down, the client is disconnected from the central database as well as from the business logic software and ceases to function.

Another severe drawback is the high probability of bottlenecks around the server and the communication network. While every service-call leads to usage of the same single database and the same single business logic software. This topology is prone to become overloaded at critical periods when many clients are trying to get services from the server.

An additional drawback is the relatively long response time—since each service call from the client leads to a roundtrip of data from the client to the server and back to the client. In some cases the server and the client may be deployed in different continents. Additionally, the database itself may be split between various sub divisions where a single service-call may lead to data retrieval from a plurality of sites and additional processing.

The traditional approach for addressing the problem of communication failure between the server and the client is the “data centric approach” which is focused around moving sections of the database and business logic to the client. According to the traditional approach, when communication is down the client uses local business logic and local data to provide the user with the required services. However beyond the problem of data synchronization between the client and the server, this approach has some severe drawbacks.

A first drawback is that this approach requires installing both database and business logic at the client, reducing significantly the advantage of easy maintenance of the pure server-client topology.

Another drawback of the traditional approach is that the software application that runs on the client should be written originally to support the business logic. It should be noted that on a pure server-client system, the client application is typically not aware of the business logic. The client application is simple software that knows how to launch simple requests (service-calls), and to intercept final results for providing the user with a graphical display. Evidently this traditional approach does not suggest any modular solution to upgrade an existing application to support offline functionality or client caching functionality—since such upgrading requires the modification of the application program at the client and also requires the client to become aware of the business logic. Furthermore this approach requires the exposure of at least part of the business logic as well as part of the database structure to the client, which in many organizations is not acceptable due to information security restrictions.

### SUMMARY OF THE INVENTION

An aspect of an embodiment of the invention relates to a method and system for managing a cache unit in a server-client environment which handles the data as pairs of service-call requests (“service-calls”) and service-call responses associated with corresponding validity conditions. A list of cacheable service-calls is maintained in the cache unit while data storage and retrieval is performed with reference to the list, thus providing a caching method and system that does not interfere with the business logic and does not require storing large portions of the database in the cache, either at the client or at the server.

In an exemplary embodiment of the invention, the cache unit according to the present invention resides at the client, thus providing partial offline functionality of the system.

In an exemplary embodiment of the invention the cache is designed to support a prediction mode, wherein according to directives from either the client or the server or both, the server will push cacheable data to the client cache, or to the server cache, or to both, preferably during idle time.

In another exemplary embodiment of the invention, prediction mode is configured by software that gathers statistics of the client's activity, or applies another heuristic method in order to improve cache functionality by predicting future service calls.

In an exemplary embodiment of the invention, there is provided a method and a system for managing a cache in a server-client environment, where it is possible to convert a system which does not support caching to a system that supports caching, without changing the business logic and without any interference with the existing system.

There is thus provided in accordance with an exemplary embodiment of the invention, in a server-client environment a method for controlling a cache, the method including the steps of:

defining a list of cacheable service-call requests;

associating each of the cacheable service-calls requests with validity conditions;
selectively storing in the cache indicative information entries corresponding to the listed cacheable service-call requests together with their corresponding service-call responses;
intercepting by the cache each service-call request; and
providing a service-call response to service-call requests with matching indicative information to the entries in the cache, provided that the associated validity conditions are met.

Optionally, the server-client environment is a 2-tier system. Alternatively, the server-client environment is a 3-tier system. In an exemplary embodiment of the invention, the cache is positioned at the server. Optionally, the cache is positioned at the client. In an exemplary embodiment of the invention, the defining is performed by the server. Optionally, the defining is performed by the client. In an exemplary embodiment of the invention, the defining is performed by software. Optionally, the defining is based on previous service-call requests. In an exemplary embodiment of the invention, the defining is based on user selections. Optionally, the defining is based on system administrator selections. In an exemplary embodiment of the invention, the validity conditions include temporal considerations. Optionally, the selectively storing in the cache indicative information entries together with their corresponding service-call responses includes a prediction mechanism which defines a prediction-list of service-calls and autonomously stores in said cache indicative information corresponding to at least some of said service-calls that are listed in said prediction-list of service-calls together with their corresponding service-call responses. In an exemplary embodiment of the invention, the prediction mechanism defines said prediction-list of service-calls according to at least one of the following considerations: client role definition, the specific service call usage statistics, an administrative provided list and user requests. Optionally, the prediction mechanism defines said prediction-list of service-calls according to programmable considerations.

There is additionally provided according to an exemplary embodiment of the invention, a caching system to be used in a server-client environment, comprising:

a cache unit including a programmable list of cacheable service-calls together with corresponding validity conditions, the cache unit is adapted to intercept service-call responses sent by the server and store the service-call responses which have a matching entry in the list of cacheable service-calls, the caching unit is further adapted to intercept service-calls sent by the client and provide the client with a service-call response for service-calls that have a matching service-call response stored in the cache unit, provided that the corresponding validity condition is met. Optionally, the definition of the list of cacheable service-calls is configurable by the server, the client or both. In an exemplary embodiment of the invention, selectively storing in the cache indicative information entries together with their corresponding service-call responses includes a prediction mechanism which defines a prediction-list of service-calls and autonomously stores in the cache indicative information corresponding to at least some of the service-calls that are listed in the prediction-list of service-calls together with their corresponding service-call responses. In an exemplary embodiment of the invention, the configuration of the list of cacheable service-calls is conducted by software.

### BRIEF DESCRIPTION OF THE DRAWINGS

The present invention will be understood and appreciated more fully from the following detailed description taken in conjunction with the drawings. Identical structures, elements or parts, which appear in more than one figure, are generally labeled with a same or similar number in all the figures in which they appear, wherein:

FIG. 1 is a block diagram of a 2-tier server-client system, according to an exemplary embodiment of the invention;

FIG. 1A is a block diagram of a 3-tier server-client system, according to an exemplary embodiment of the invention;

FIG. 2 is a flow chart illustrating the steps of sending a service-call in a server-client system, according to an exemplary embodiment of the invention;

FIG. 3 is a block diagram of a cache control unit, according to an exemplary embodiment of the invention;

FIG. 3A is a schematic illustration of a single cache memory entry in a cache memory unit according to an exemplary embodiment of the invention;

FIG. 4 is a flow diagram illustrating the steps of extracting cacheable service-calls to a list, according to an exemplary embodiment of the invention;

FIG. 5 is a table illustrating a preliminary sorting of available service-calls in a list, according to an exemplary embodiment of the invention;

FIG. 6 is a flow diagram illustrating the process of responding to a service-call that originated in the client, according to an exemplary embodiment of the invention;

FIG. 7 is a flow diagram of the decision process regarding storage of service-call responses arriving from the server in a cache memory unit, according to an exemplary embodiment of the invention;

FIG. 8A is an illustration of a client screen including a pop-up menu to be used by a user, according to an exemplary embodiment of the invention; and

FIG. 8B is a general example of the appearance of service-calls and service-call responses in a server-client application program.

### DETAILED DESCRIPTION OF THE INVENTION

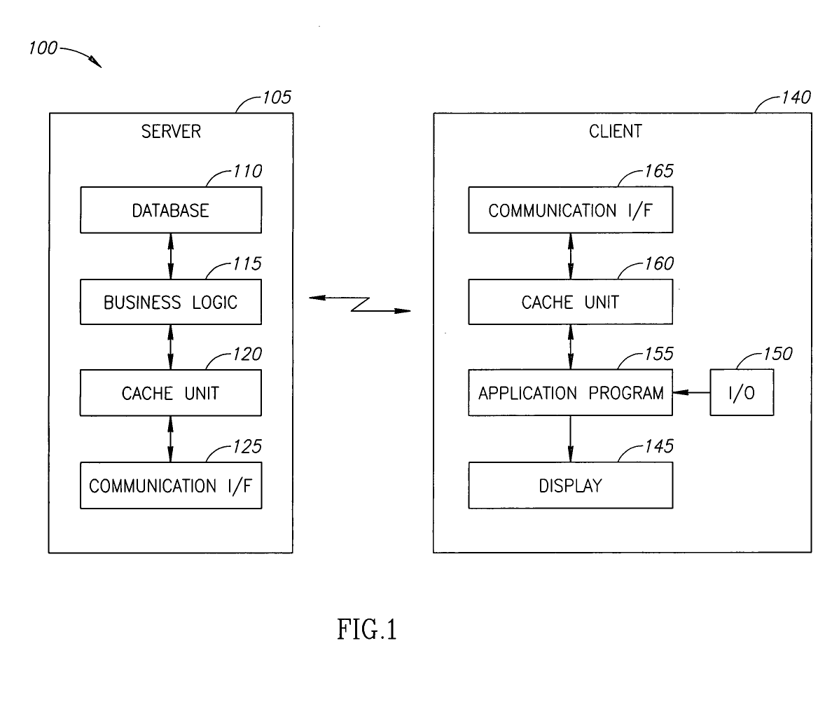

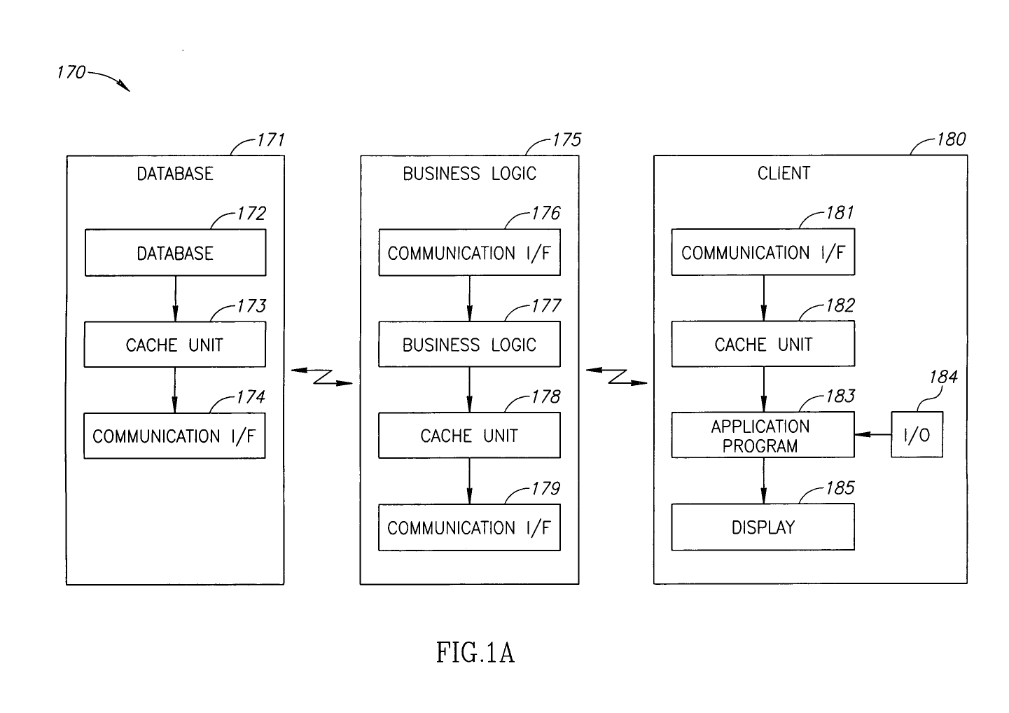

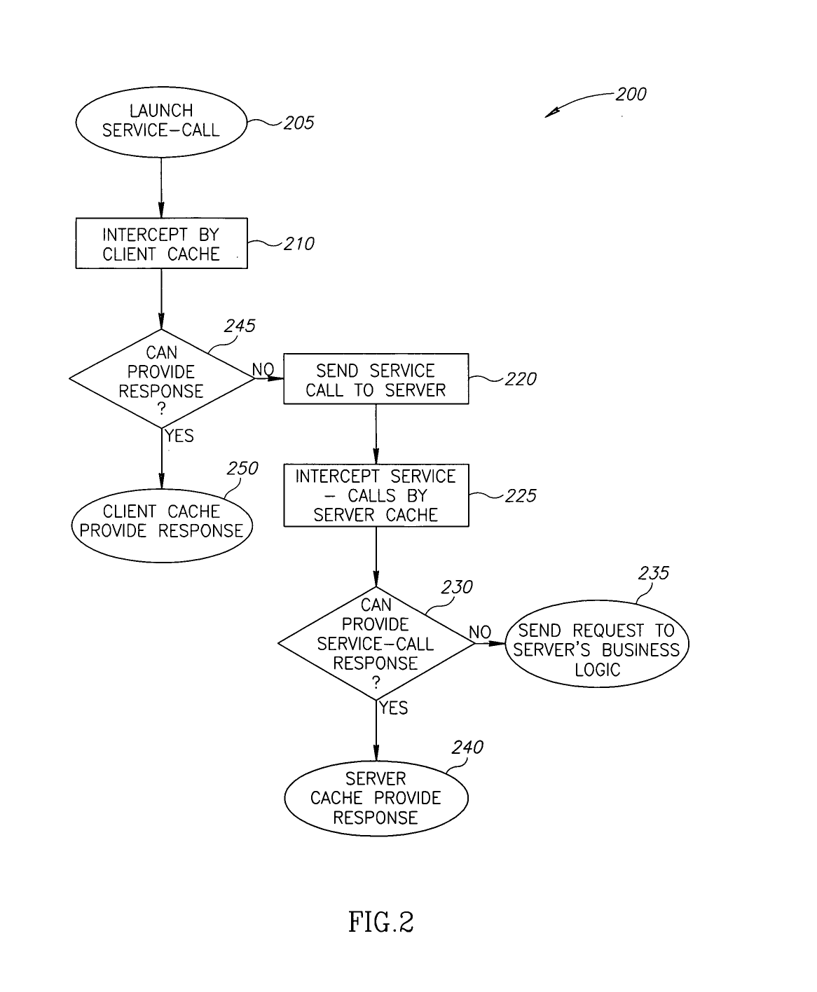

In order to understand the invention the general concept of the server-client environment including a client cache and a server cache unit is described with reference to FIGS. 1 and 2.

FIG. 1 is a block diagram of a 2-tier server-client system 100. Server client system 100 comprises two main parts: a server 105 and one or more clients 140. Server 105 includes a business logic section 115, a database section 110, a cache unit 120, and a communication interface 125. Optionally, business logic section 115 handles the provision and implementation of rules and/or algorithms to process data. Database section 110 handles storing and retrieving of the data handled by server 105. Cache unit 120 provides a high speed memory for temporarily storing data as it is being extracted/provided from/to database section 110 and/or communication interface 125. Communication interface 125 handles reception of messages and data from clients 140 and transmission of messages and data to clients 140. It should be noted that the server unit illustration in FIG. 1 represents the general logic scheme of server 105, whereas the actual server may comprise a single computer or a network of computers providing service to clients 140. Likewise database 110 is illustrated as one unit. However it could be physically and logically divided to sub units which reside near each other or at different sites remote from each other.

Client 140 preferably comprises five main sub units:

1. An application program unit 155, which represents the client side application, for example an application for serving an insurance agent.

2. A display unit 145, for example a monitor.

3. A cache unit 160 that serves as a mediator layer between server unit 105 and application-program unit 155 to speed up data access and to enable offline functionality.

4. An I/O unit 150 to provide user input to client unit 140, for example using a keyboard and a mouse.

5. A communication interface 165 to communicate with server unit 105 via communication interface 125.

FIG. 1A shows a block diagram of another exemplary embodiment of the invention wherein the server-client system is a “3-tier” server-client system 170 where the system includes three main components:

A client 180 having a display unit 185, an application program unit 183, an I/O unit 184, a cache unit 182 and a communication unit 181.

A business logic component 175 having a business logic unit 177, a cache unit 178 and two communication Interfaces (I/F) 176, 179.

A database component 171 having a database unit 172, a cache unit 173 and a communication I/F 174.

It should be noted that any of the cache units 173, 178 or 182 is optional and therefore may exist or may not exist in a 3-tier server-client system.

Since the functionality of the caching mechanism in a 2-tier and 3-tier server-client systems is almost identical—the following descriptions will refer to the 2-tier server-client system shown in FIG. 1. However it should be noted that in the following description, client cache unit 160 and client cache 182 are interchangeable as well as server cache unit 120 and any of the cache units 173 and 178.

The data flow of server-client system 100 is described with reference to FIG. 2 in a flow diagram 200. In an exemplary system, a user of client 140 launches a service-call (205) by clicking a mouse or using a keyboard. Application program 150 translates the user input into a specific service-call.

In an exemplary embodiment of the invention, service-calls are of various types, resulting with various service-call response types. One type of service-call is a “read service-call”, for example a “read service-call” may represent questions such as: how many cars of type A were sold last year? What is the expiration date of insurance policy B? How many seats are still available on a certain flight? It should be noted that while the questions “What is the expiration date of insurance policy B?” and “What is the expiration date of insurance policy C” have some common elements—they are considered as two different service-calls.

Another type of service call is a “write service call”—wherein the client requests to update the server's database—for instance to update the database with the information that a car of type “D” has just been sold.

Another type of service-call is a “local business logic service-call”, for example a request to validate complex input values—for instance to check the validity of a provided credit card number. This validation process is a simple computing task that actually performs the same computing routine for any provided number and results with a valid/non-valid result. Since the validation involves very simple logic and it does not have any dependency or influence on the database, there is no need to involve server 105 in this type of process such a service-call is usually handled locally by application program 155.

In an exemplary embodiment of the invention, the service-call is sent from application program 155 to server 105 but it is first intercepted (210) by cache unit 160. Cache unit 160 has two options (245) for handling the service-call, either to route the service-call directly to server 105 (220)—and in this case cache unit 160 does not actually take any part in the system functionality apart from serving as a pipe for information flow. Alternatively, if a valid service-call response is found in cache unit 160, cache unit 160 provides application program 155 with a service-call response (250). Optionally, the response will be translated for display 145 so that it may be viewed by the user. As an example a user may inquire regarding the numbers of cars of class “A” which were sold in the previous year, and the answer will be provided by cache unit 160 as a number which will be displayed on the monitor, for example in the form of a text entry or as a graphical display (e.g. a histogram).

In the case that cache unit 160 cannot provide a service-call response, the service-call will be transmitted through communication interfaces 165, 125 and will be intercepted (225) by cache unit 120. Likewise cache unit 120 of server 105 will provide a service-call response (240) or send (235) the service-call to business logic unit 115 of server 105, depending on the ability of cache unit 105 to provide a response (230) to the service call.

Business logic 115 of server 105, comprises knowledge (e.g. rules, algorithms) to extract responses to service-calls from the data that is stored in database 110, which may be dispersed over multiple physical entities. Business logic 115 retrieves the required data from database 110 to manipulate the data and provide a service-call response. As an example the answer to the question regarding the number of cars of class “A” that were sold last year may require gathering data from three database sites, wherein each database site stores only regional data. If however cache unit 120 of server 105 can provide the response it will be provided from data that is stored in cache unit 120.

The current invention relates to a method of client cache implementation and to a server-client system that implements this cache methodology. The invention is also applicable as a method and system of server cache implementation. In an exemplary embodiment of the invention, the client cache suggests a solution for occasionally connected server-client systems. Optionally, the server side cache reduces response times and lowers the load on a busy system although it does not provide a solution for an offline client. However a server cache unit has an advantage over a client cache by enabling the use of the content of the server cache to serve a plurality of clients while a client cache provides cache services just for the single client of the station in which it resides.

The present invention suggests a method in which all cacheable data (as will be further described, the term “cacheable data” should be interpreted as “data that is allowed to be cached” according to the following description and not as it's general meaning) is defined as pairs of service-calls and service-call responses. In an exemplary embodiment of the invention, a validity condition is associated with each pair to define a time span wherein a previously cached value should be regarded as valid. This approach is very efficient in many commercial (but not only commercial) server-client systems and suggests a caching solution where the cache does not require any modification of the business logic and does not require the storage of large portions of the database at the client cache, but only those entries which are characterized by high probability of being further used.

According to the method and system disclosed by the present invention there are two phases in the cache operation: The first phase is a configuration phase where a list of cacheable service-calls is constructed and validity conditions are associated therewith, this list of cacheable service-calls is loaded to the cache and will serve as a reference for the cache control unit at each point in time when a decision should be taken whether to store a service-call response in the cache or at points in time when a decision should be taken whether a service-call response could potentially be found in the cache.

The second phase is a run-time phase wherein the cache is loaded according to its configuration and provides service-responses from data that is already stored in the cache's memory. It should be noted that as will be further described, the configuration phase may overlap with the run-time phase since the cache configuration may change dynamically.

It should be further noted that the meaning of a list of cacheable service-calls should be construed widely as any data structure from which a logic unit may get enough information to decide whether to store a certain arriving service-call response or whether a certain service-call response could be potentially found in the cache. The same applies for the meanings of cache control unit, cache configuration unit and cache memory unit. In the disclosure below these terms refer to exemplary embodiments and should not be construed as limiting the scope of the invention to a specific cache unit structure.

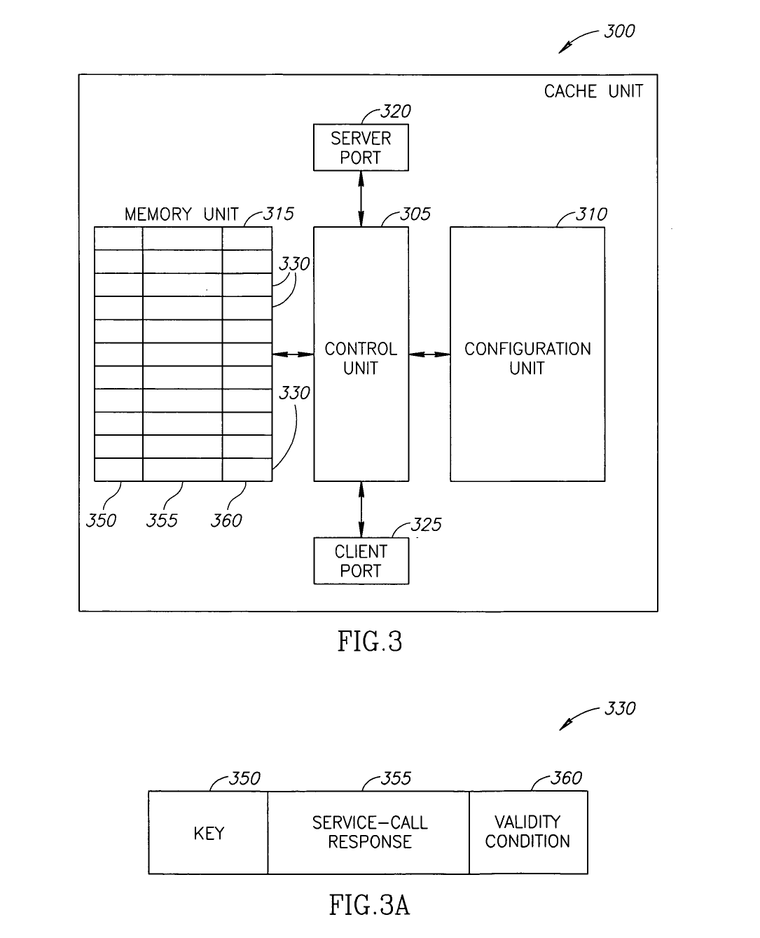

FIG. 3 shows a block diagram 300 of cache unit 160 (for the client) (or 120 (for the server)) according to an exemplary embodiment of the invention. In an exemplary embodiment of the invention, cache unit 160 (or 120) includes three main sub units:

1. A memory unit 315, which stores a plurality of memory entries 330 as described below;

2. A configuration unit 310, which stores input data from either the server or the client that includes directives regarding the desired mode of operation in which the server or the client wants the cache to function; and

3. A control unit 305, which controls the logical operation of the cache according to the configuration that was defined in the configuration unit 310.

Cache unit 160 (or 120) further includes two bidirectional ports: a server-end port 320 and a client-end port 325. Ports 320 and 325 receive and transmit data to/from the cache unit—according to the data flow direction.

In an exemplary embodiment of the invention, each entry of data in memory unit 315 includes three sections. FIG. 3A is a schematic illustration of a single cache memory entry 330 in memory unit 315 according to an exemplary embodiment of the invention. Optionally, each memory entry 330 comprises a key field 350 which includes indicative information about the specific service-call. The keys provide a mapping between specific service-calls and a physical or logical address in memory unit 315, for example a key entry may be an actual XML command instance (both type and specific input parameters) as it originally appears in an application code, or alternatively it could be a serial number between one to n, wherein n represents the number of cacheable service-calls in a given application. Optionally, control unit 305 includes the logic knowledge to associate each serial number with a corresponding service-call.

In an exemplary embodiment of the invention, each entry further includes a service-call response field 355 or alternatively any data from which a service-call response can be provided by a simple logic that resides in control unit 305.

The third section 360 includes validity condition data to define the conditions under which memory entry 330 is valid. Optionally, the validity conditions may include temporal considerations such as time of day or the time that has passed since receiving the cached value.

In an exemplary embodiment of the invention, Configuration unit 310 is provided with information about cacheable service-calls, for example the information will define which service-calls are cacheable, what mechanism is used for updating the list of cacheable service-calls, and what validity conditions will be associated to each service-call. Optionally, control unit 305 is mainly functional during run-time of an application when a service-call is intercepted in the cache. Control unit 305 decides whether a valid service-call response is to be delivered from memory unit 315. Additionally, when a service-call response from server 105 is intercepted by the cache unit, control unit 305 decides whether to store a copy in memory unit 315 or to pass it to application program 155 without backing it up. This decision is based on the contents of configuration unit 310.

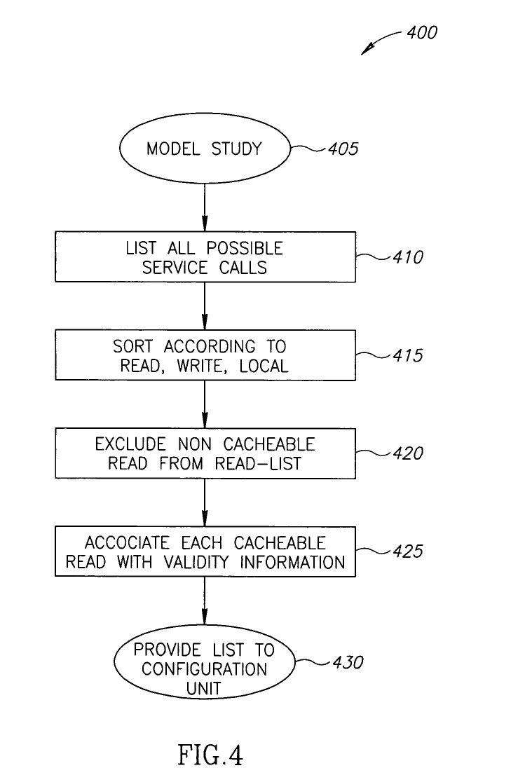

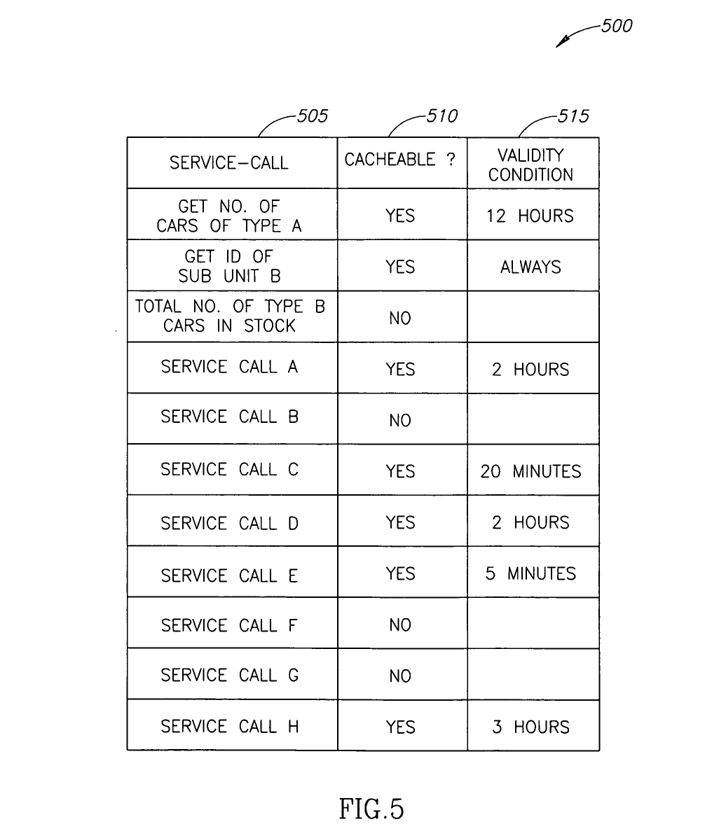

As mentioned above, in order to configure the cache unit, a list of cacheable service-calls should first be extracted. Optionally, the list of cacheable service-calls could be extracted in several ways. One of the ways for creating the list of cacheable service-calls is by analyzing business logic 115. The guidelines for processing business logic 115 are described with reference to FIG. 4 and FIG. 5.

FIG. 4 is a flow diagram 400 illustrating the steps of extracting cacheable service-calls to a list, according to an exemplary embodiment of the invention. FIG. 5 is a list 500 illustrating a preliminary sorting of the service-calls in the list, according to an exemplary embodiment of the invention.

In an exemplary embodiment of the invention, an application model is first studied (405) to identify the cacheable service-calls.

It should be noted that the efficient functionality of the method and system according to the present invention requires, in most cases, a thorough understanding of the application. As will be further disclosed the invention depends on the ability to identify in the application (business logic 115) pairs of service-calls and their corresponding responses. Additionally, creation of the list requires association of a validity condition to each of the pairs. In most cases a thorough understanding of the application is required since the service-calls are very much context dependant.

In order to understand to what extent a service-call may be context dependant an example is provided below describing a service-call that can be implemented in two different applications, and is treated differently in each application.

Assume a service-call that inquires about the number of bottles of wine of type “A” that are available in the inventory. A first application is a general inventory management application that is used by a large wholesale firm having hundreds of branches across the country. The second application is serving auction dealers while conducting a public auction sale.

It is clear that in the first case, when a manager launches a service-call inquiring for the number of wine bottles of type “A” in the inventory, accuracy is not very important. The difference between a response of “four thousand wine bottles” and a response of “three thousand and eight hundreds wine bottles” to the manager is of little consequence. However in the second application there is a critical difference for an auction dealer between a response of “two bottles” or “zero bottles”.

Therefore the exact same service-call, which may use exactly the same syntax in both applications may be defined as cacheable in the first application—where the validity of an offline service-call response after being offline for half an hour is acceptable, and should be defined as non cacheable in the second application. Hence it is understood that the service-call appearance in the code usually does not provide enough information as to whether it could be defined as cacheable.

In an exemplary embodiment of the invention, after studying the application model, a listing (410) of the possible service-calls that may be launched by the client is assembled. Optionally, the list may be organized as shown in list 500 (FIG. 5.) to include one entry for each of the possible service-calls 505.

Identification of all the service-calls in a given application is a technical issue known in the art. In an exemplary embodiment of the invention an administrator or a programmer or any other person skilled in the art may identify service calls by reviewing the text of the application, which may be for example an Adobe flash based application which is compiled from a Visual Composer model. This task requires just a basic knowledge of the service-calls format and may be done using any text editor or basic scripting language like “awk” or “perl” or even by using basic operating system commands (like the Unix “grep” command.).

According to an exemplary embodiment of the invention, all possible service-calls may be sorted (415) according to three categories: (a) “read service-calls”; (b) “write service-calls”; and (c) “local service calls”.

“Read service-calls” are service-calls that request data from the server. “Write service-calls” are service-calls that are designated to update or change data in the server's database and therefore this type of service-call is not a candidate for caching since they do not expect to get data from the server's database other than optionally acknowledging the request.

Optionally, “local service-calls” will never reach the cache unit—since they will be locally responded to by the application program, and therefore they are not candidates for caching. It is evident that sorting the service-call may be conducted according to any criteria as long as it provides a sorted list of cacheable service-calls.

After sorting the service-calls, all non cacheable service-calls are excluded from the list (420), and marked as non cacheable in list 500 column 515. A non cacheable service-call may be defined as non-cacheable for various reasons, for example a read service-call that inquires for sensitive data that is not allowed to be kept at the client, or a read service-call that inquires for data that is valid only for a few seconds would be defined as non cacheable. Another type of read service-calls which may be defined as non cacheable are “open questions” or “cross section questions”, for example a service-call in an application that provides an inquiry regarding the number of subscribers that were born between two selected dates for example between January 12 and March 17. In an exemplary embodiment of the invention, if the application allows the user to perform this type of service-call, the probability that exactly the same service-call will be launched again in a reasonable period is (in most cases) negligible, and therefore there is no reason to store such data. Further-more such “open question” are practically resulting with an excessive amount of different service-calls which turns this type of service-call to be less appropriate for caching.

All the read service-calls that were not excluded are marked as cacheable 510.

In an exemplary embodiment of the invention, after removing non-cacheable service-calls a validity condition is defined (425) for each service-call (column 515 in list 500). In some embodiments of the invention, the validity condition is the time-frame in which a service-call response is assumed to remain valid after communication failure occurs, for example a service-call that inquires for the number of available cars in an importer's warehouse may be assumed valid for a few hours while a stock rate in a stock trading application may be considered valid during a time frame of ten seconds or less during the hours of stock commerce. In contrast the ID number of a subscriber should be considered “always valid”. Optionally, validity conditions may be defined by more complex formulas taking into account various kinds of parameters, for example the same service-call inquiry for a stock rate may be defined valid for ten seconds between the hours nine am to four pm when the stock exchange site is active and assumed valid for three hours at times when the stock exchange site is closed for trading.

The process described above provides a list of cacheable service-calls 505 (associated with corresponding validity conditions 515). This list is the basic data that is required by cache configuration unit 310. In an exemplary embodiment of the invention, configuration unit 310 is able to function based on this data. Optionally, client 140 and/or server 105 may provide updates to the details listed in configuration unit 310 during operation of system 100. In accordance to an exemplary embodiment of the invention, each of the client users or a server administrator may update the list, change validity conditions, modify priorities of the cache unit and change any other parameter.

According to an exemplary embodiment of the present invention, the details in configuration unit 310 may be modified by software utilities that for example collect statistical data regarding service-call usage by a client and modify the client's configuration unit 310 accordingly. An example of such an implementation is programming a cache unit to store service-calls which were most frequently used during a specific time span such as the previous forty eight hours. Optionally, after the selected time span service-calls that are not invoked again will be removed. This optional feature is important in cases where memory unit 315 is of a limited size. In some embodiments of the invention, cache unit 120/160 utilizes a prediction mode. Prediction mode is a method in which server 105 pushes data to cache 120/160 according to a prediction process/algorithm which may be conducted at the server or at the client. Optionally, the server will autonomously store information in cache 120/160 at times determined by the server based on the statistical predictions.

In an exemplary embodiment of the invention, the client user may know that the next day he will be using certain information from the database, the system according to the present invention enables the client to order data by indicating service-calls that should be pre-performed by server 105 and provided to server cache unit 120, and then to client cache unit 160 when a connection with the client becomes available. Optionally, a system administrator may initiate the provision of data to a cache according to system considerations, for example to reduce the data processing load in the morning by having common client service-calls already available in the server cache. In some embodiments of the invention, company policy may dictate preparation of data in prediction mode, for example loading the server cache or client cache with data that the client is required to request at specific times, thus eliminating the need to provide the data on demand and prevent slowdown of the system at peak times.

In an exemplary embodiment of the invention application program 155 may support a pop-up menu which appears on display 145, suggesting to the user of client 140 to enter data for prediction mode configuration. As an example an insurance agent program application 155 may suggest to the user to input via I/O device 150 (e.g. the keyboard, or the mouse), which region he intends to cover on the next day. If the user-insurance agent, selects “north”, the cache unit 160 will forward this information to server 105, which during the night or during any other idle period (depending on further configuration inputs or default settings) will try to push all the cacheable entries concerning all the insurance policies handled by the specific insurance agent that were issued in the region that is defined as “north”.

In an exemplary embodiment of the invention prediction mode is driven in by a history-based algorithm. Optionally, in this mode the server will use idle times, for example during the night, to load the cache with pairs of service-calls and their corresponding service-calls responses (including their corresponding validity conditions). In this mode either the client or the server keeps a list of all recent service-calls that were launched by the client. The list is processed according to various criteria, for example selecting service-calls that were launched during the last twelve hours or service-calls that were launched more than two times during the last eight hours, yielding a list of service-calls and their corresponding server-calls responses to be loaded to the cache (either server cache or client cache or both).

In some embodiments of the invention, server 105 will load cache 120/160 with data according to list of cacheable service-calls in configuration unit 310 at a predefined time. In an exemplary embodiment of the invention server 105 will load cache 120/160 with data early in the morning when communication networks are usually not loaded and therefore a high throughput is available, so that when the client users start to work the cache is already loaded with updated data which is characterized by having a high probability of being required by the client user.

In an exemplary embodiment of the invention, system 100 differentiates between different time intervals by caching different service-calls at different times based on the client's activity at different times, for example system 100 may cache different data on weekends in contrast to workdays, or in the morning relative to the afternoon. An example of such an implementation may refer to an agent in an insurance agency wherein the agent typically performs a first type of activity in the morning and a second type of activity in the afternoon. The list of cacheable data for the morning will include the service-calls which refer to the service-calls that are typically launched in the morning, while the list of data to cache in the afternoon will include only the service-calls which refer to the service-calls that were launched in the afternoon.

It should be noted that the above described considerations and algorithms for building the list of data to cache are provided as non limiting examples. Optionally, prediction mode as described above to be based on history (e.g. statistical information) may rely on any algorithm that exploits the ability of identifying repetitive patterns of performing service-calls by a user.

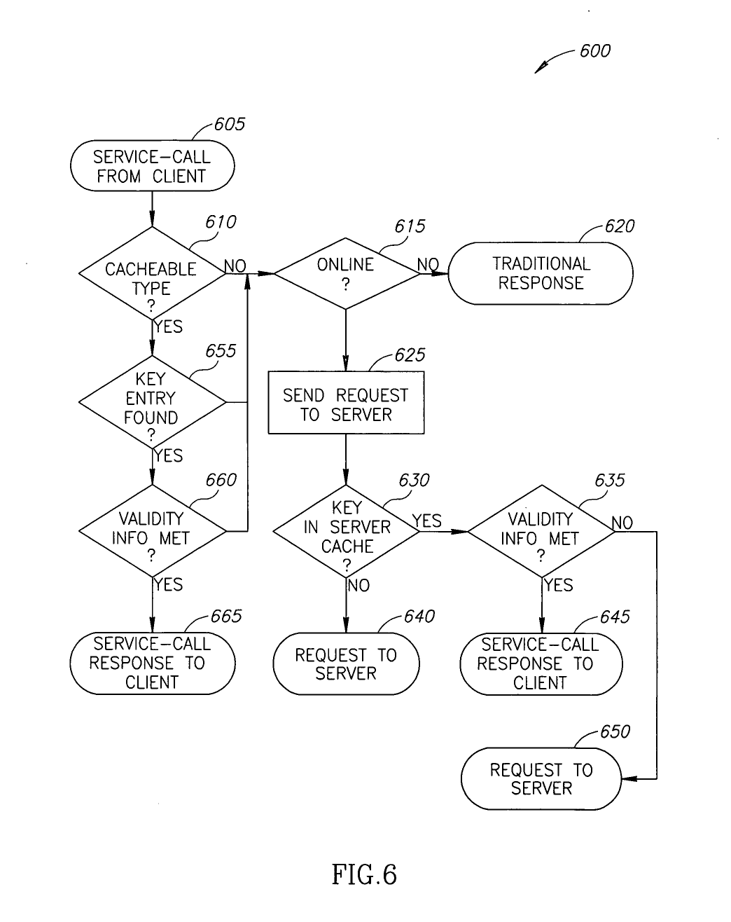

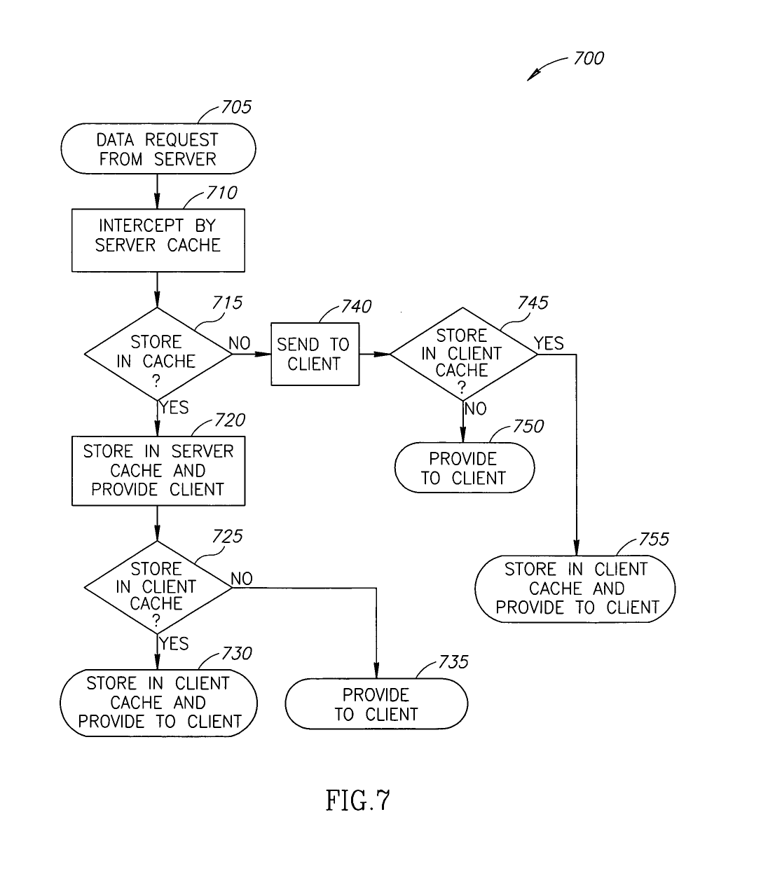

In an exemplary embodiment of the invention, data flow using cache 120/160 as described above is illustrated with reference to FIGS. 6 and 7. Data flow from client 140 (e.g. a service-call) to server 105 is described with reference to FIG. 6 and data flow from server 105 to client 105 (e.g. server-call response) is described with reference to FIG. 7.

FIG. 6 is an illustration of a flow diagram 600 of a service-call which is launched (605) by client 140. The service-call is intercepted by cache unit 120/160 and analyzed to determine (610) if it is of a cacheable type. As described above cache unit 120/160 maintains list 500 of all cacheable service-calls and in determining (610) a search is conducted to locate the service-call. If the service-call is not cacheable, system 100 optionally checks if client 140 is currently online (615). If there is a live connection between client 140 and server 105 the service-call will be sent (625) to server 105. In an exemplary embodiment of the invention, cache unit 120 at server 105 intercepts the service-call and checks (630) if there is a matching key in cache unit 120. If a matching key is found the validity condition will be checked (635) to determine if the cached data may be used. If the cached data is valid cache unit 120 will provide (645) the response data to client 140. If the validity condition is not met the service-call will be sent (650) to business logic 115 of server 105.

If the service-call from client 140 is determined (610) to be cacheable—a search for a matching key will be conducted in the cache unit 160. If no matching key is found the flow continues as if the service-call is not cacheable (670). If a matching entry is found, the cache unit will check (660) if validity conditions are met according to the validity condition that is associated to the specific service-call. If validity conditions are met, cache unit 120 will provide (665) a service-call response. If validity conditions are not met the flow proceeds as if the service-call is not cacheable (670).

It should be noted that determination if a service-call is cacheable is not necessarily the same for cache unit 120 at server 105 and cache unit 160 at client 140.

FIG. 7 illustrates a flow diagram 700 of the opposite direction. In an exemplary embodiment of the invention, a service-call response is sent (705) from server 105. The service-call response is intercepted (710) by cache unit 120. Cache unit 120 determines (715) if the service-call response is of a type that is cacheable by cache 120. If the response is cacheable it will first be stored in cache unit 120 and then be provided (720) to the application program 155 at client 140. Optionally, at client 140 the service-call response is intercepted by cache unit 160. Cache unit 160 determines (725) if the response should be stored in cache 160. If the service-call is cacheable by cache unit 160 according to cache configuration 310, the service-call response will be stored in cache unit 160 and simultaneously be sent to application program 155 to be displayed (730) to the end-user. If the response is not cacheable by cache unit 160 it will be provided (735) directly to the end user without storing it in cache unit 160.

On the other hand if the service-call was defined as non-cacheable by the cache unit 120 it will be sent (740) to cache unit 160 at client 140. Cache unit 160 will determine (745) if the service-call is cacheable. If it is cacheable according to cache configuration 310—it will be stored in the cache unit 160 and simultaneously provided (755) to application program 155. If however, the service-call is found to be not cacheable it will be provided (750) to the client application program without being stored in the client cache.

It should be noted that any configuration of cache deployment is possible—a cache may exist in the client side or in the server side or both. However if there is a cache unit at both sides it does not mean that data storing policy should be equal at both caches, since the server cache is typically serving many clients so the considerations that are taken are different from those at the client side.

While the data flow description is focused on “read service-calls”, the server-client system needs also to take care of “write service-calls”—when data is sent from the client to the server, for example an insurance agent reports the sale of an insurance policy or a sales agent reports the event of a car of type “AA” being sold. Assuming such an event occurs during the system being offline—the system provides a method for orderly caching on the client the set of required actions (“write” or “update” service-calls) while offline, thus keeping track of the required updates and “replay” the set of update/write service-calls versus the server when returning to on-line state again. However this type of mechanism is not necessarily derived from the unique caching method of the present invention and thus it will not be further described.

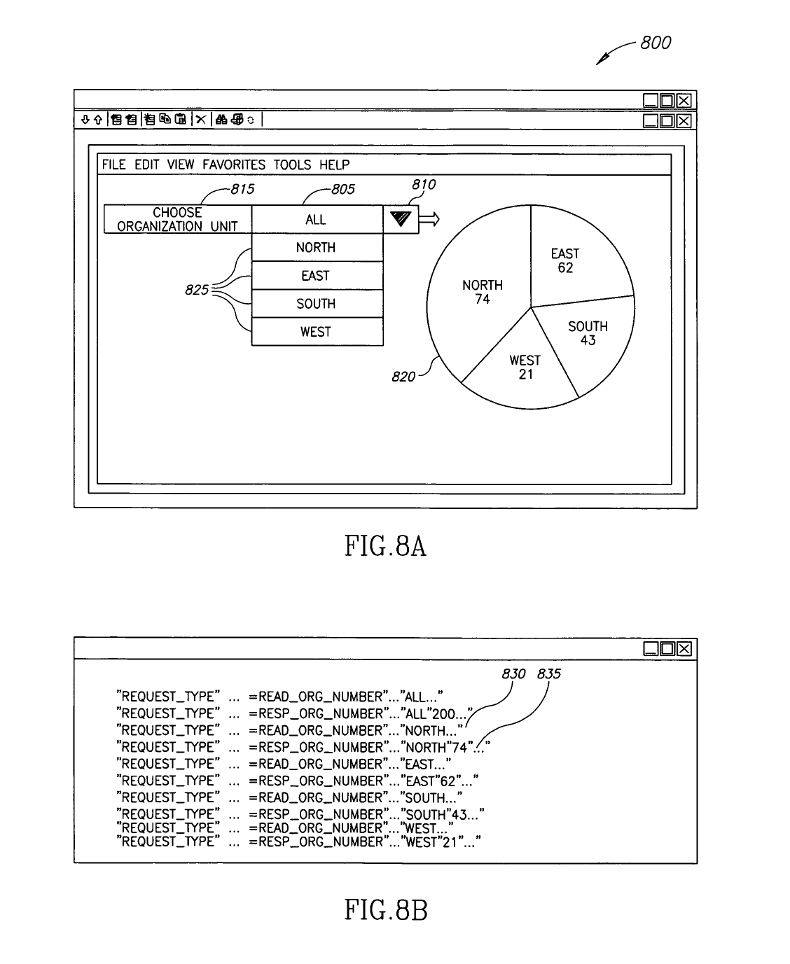

In order to enhance comprehension of the relationship between a specific screen view of an application and the visual appearance of service-calls in an exemplary application an example is given with reference to FIG. 8 and FIG. 8A.

FIG. 8A is an illustration of a monitor screen 800 where the user may click an arrow 810 to select from a pop-up menu 825 one of five options: “all”, “north”, “east”, “south” and “west”. Following the selection of any of these options—the screen will be refreshed and the number of units that were sold by the selected organization unit (“all”, “north”, “east”, “south” and “west”.) during the last week will be shown in a “pie-chart” format.

FIG. 8B shows an example of the textual appearance of a pair comprising a service-call and a service-call response using XML.

At a preliminary phase, a programmer/system analyzer needs to extract the list of all possible service-calls. In order to locate the pairs in the application text (e.g. business logic 115) a search is conducted (410) to find all the strings that contain the substring “request_type”. The search is then refined to locate all the appearances of the substring “READ_ORG_NUMBER”. In this example five such strings 830 are found. Each string additionally includes one unique parameter from the list of the five regions (“all”, “north”, “east”, “south” and “west”.). These five entries will be stored in the cache together with a validity condition that was defined by the person or S/W that prepared the configuration list in memory unit 315, for example, the validity condition may be defined as “six hours” (in this case the data that is stored in the cache is assumed to be valid for six hours after a communication failure occurred).

While the application is running, assuming the cache configuration contains values for these five entries. When a service-call response is intercepted by cache unit 120/160, cache control unit 305 will search for the string “ORG_READ_NUMBER_RESPONSE” and if found the contents of the string will be stored in memory unit 315. When a service-call is intercepted by cache 120/160 cache control unit 305 identifies the substring “READ_ORG_NUMBER”—since this entry exists in the list of cacheable service-calls stored in the configuration unit 310, the cache control unit 305 will conduct a search for the specific entry in cache memory unit 315, assuming that this entry (e.g. “north”) exists in cache memory unit 315, for example containing the number “74” as shown in 835. Control unit 305 will check if the validity condition is met. Assuming the service-call response is stored in the cache for less than six hours, cache 160 (or 120) will provide the service-call response “74” to be displayed on the monitor screen.

Although it was mentioned that whenever the cache stores data that is not older than the validity condition—this data will be provided as service-call response, the system may define different validity condition for a client cache when working offline or online. When the client is offline it is clear that the data should be retrieved from the cache (if valid data is found), however, when the client is online, the system may decide to either retrieve the data from the cache or get a fresh service-call response from the server. This decision is a tradeoff between data refresh frequency and response time of the system and may result with a more complex validity condition that takes into account also a parameter of online/offline.

It should be understood that the above description is very general and it ignores the details and technical differences from a real application. For example—a real application usually runs a binary code, wherein an actual search for a string is very different from a textual search, and refreshing a monitor screen usually requires an additional service call, however these details are easily understood by one skilled in the art.

It should be appreciated that the above described methods and systems may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

Section headings are provided for assistance in navigation and should not be considered as necessarily limiting the contents of the section.

It will be appreciated by persons skilled in the art that the present invention is not limited to what has been particularly shown and described hereinabove. Rather the scope of the present invention is defined only by the claims, which follow.

1. In a server-client environment a method for controlling a cache, the method comprising the steps of:
defining a list of cacheable service-call requests;
associating each of said cacheable service-calls requests with validity conditions;
selectively storing in said cache indicative information entries corresponding to said listed cacheable service-call requests together with their corresponding service-call responses;
intercepting by said cache each service-call request; and
providing a service-call response to service-call requests with matching indicative information to the entries in said cache, provided that the associated validity conditions are met.

2. A method according to claim 1, wherein the server-client environment is a 2-tier system.

3. A method according to claim 1, wherein the server-client environment is a 3-tier system.

4. A method according to claim 1, wherein said cache is positioned at the server.

5. A method according to claim 1, wherein said cache is positioned at the client.

6. A method according to claim 1, wherein said defining is performed by said server.

7. A method according to claim 1, wherein said defining is performed by said client.

8. A method according to claim 1, wherein said defining is performed by software.

9. A method according to claim 1, wherein said defining is based on previous service-call requests.

10. A method according to claim 1, wherein said defining is based on user selections.

11. A method according to claim 1, wherein said defining is based on system administrator selections.

12. A method according to claim 1, wherein said validity conditions include temporal considerations.

13. A method according to claim 1, wherein said selectively storing in the cache indicative information entries together with their corresponding service-call responses includes a prediction mechanism which defines a prediction-list of service-calls and autonomously stores in said cache indicative information corresponding to at least some of said service-calls that are listed in said prediction-list of service-calls together with their corresponding service-call responses.

14. A method according to claim 13, wherein said prediction mechanism defines said prediction-list of service-calls according to at least one of the following considerations: client role definition, the specific service call usage statistics, an administrative provided list and user requests.

15. A method according to claim 13, wherein said prediction mechanism defines said prediction-list of service-calls according to programmable considerations.

16. A caching system to be used in a server-client environment, comprising:
a cache unit including a programmable list of cacheable service-calls together with corresponding validity conditions, said cache unit is adapted to intercept service-call responses sent by the server and store the service-call responses which have a matching entry in the list of cacheable service-calls, said caching unit is further adapted to intercept service-calls sent by the client and provide the client with a service-call response for service-calls that have a matching service-call response stored in the cache unit, provided that said corresponding validity condition is met.

17. A caching system according to claim 16 wherein, the definition of said list of cacheable service-calls is configurable by the server, the client or both.

18. A caching system according to claim 16 wherein, said selectively storing in the cache indicative information entries together with their corresponding service-call responses includes a prediction mechanism which defines a prediction-list of service-calls and autonomously stores in said cache indicative information corresponding to at least some of the service-calls that are listed in the prediction-list of service-calls together with their corresponding service-call responses.

19. A caching system according to claim 16 wherein the configuration of said list of cacheable service-calls is conducted by software.
